(19) United States
(12) Patent Application Publication
(10) Pub. No.: US 2015/0159061 A1
(43) Pub. Date: Jun. 11, 2015

(54) PHENOL-FORMALDEHYDE AND LIGNIN PHENOL-FORMALDEHYDE ADHESIVE POLYMERS WITH CARBON BLACK, AND METHOD OF MAKING SAME

(71) Applicants: Lamfeddal Kouisni, St-Leonard (CA); Michael Paleologou, Beaconsfield (CA); Yaolin Zhang, Quebec (CA); Xiang-Ming Wang, Quebec (CA); Martin Feng, Vancouver (CA)

(72) Inventors: Lamfeddal Kouisni, St-Leonard (CA); Michael Paleologou, Beaconsfield (CA); Yaolin Zhang, Quebec (CA); Xiang-Ming Wang, Quebec (CA); Martin Feng, Vancouver (CA)

(21) Appl. No.: 13/983,273

(22) PCT Filed: Feb. 10, 2012
(86) PCT No.: PCT/CA2012/000117

§ 371 Date: Oct. 11, 2013

Related U.S. Application Data
(60) Provisional application No. 61/441,797, filed on Feb. 11, 2011.

(51) Int. Cl. C09J 161/06

(52) U.S. Cl. CPC C09J 161/06

(57) ABSTRACT

Phenol-formaldehyde and lignin-phenol formaldehyde adhesive polymers with improved properties are disclosed, as well as the method of production therein. The method comprises providing at least one phenolic compound at least one formaldehyde compound, an alkali metal hydroxide, water and at least one carbon black; mixing the at least one phenolic compound, the at least one formaldehyde compound, the alkali metal hydroxide, the water and the carbon black to produce a methylolation medium at a pH of about 10 or less; maintaining the medium at a methylolation temperature to produce a methylolated medium reacting with the water predominantly; and increasing the temperature of the methylolated medium to produce the phenol-formaldehyde polymer via a condensation reaction.

### FIELD OF THE INVENTION

The present invention relates to a phenol-formaldehyde adhesive polymer and/or lignin-phenol-formaldehyde adhesive polymer reinforced with carbon black, a method of making this polymer and the composite products that can be produced therefrom.

### BACKGROUND

Traditional lignocellulosic composites can be classified into four main groups based on raw material geometries: veneer-based, strand-based, particle-based and fiber-based materials. The veneer-based materials are used to manufacture plywood and laminated veneer lumber (LVL), the strand-based materials for waferboard and oriented strand board (OSB) for exterior applications, the particle-based materials for particleboard, and the fiber-based materials for medium density fiberboard (MDF) and hardboard.

Wood adhesives are key components for manufacturing wood composite panels. Sellers (2001) reported that North America consumed more than 1.78×10⁸ tons of wood adhesives (based on 100% solids content) in 1998, in which urea-formaldehyde (UF) and melamine-formaldehyde (MF) adhesives accounted for around 60% of the total consumption, and phenol-formaldehyde (PF) adhesives accounted for over 35%. Because of the subsequent release of formaldehyde from wood composites made with UF or MUF adhesives, these adhesives are faced with increasingly more stringent regulations. Because phenolic resins have better thermal resistance and weather resistance than amino adhesives, PF resins are commonly used for the manufacture of OSB and exterior grade plywood. They have also been used for particleboard and fiberboard manufacturing. Furthermore, PF resins are known to have very low formaldehyde emissions from their composites products throughout the service life.

The main component of PF resins, phenol, is produced from petroleum-based products. Since petroleum resources are limited and non-renewable, the wood composites industry would benefit greatly from the development of lignin-based phenolic resins modified with carbon black as a reinforcement agent.

According to the International Carbon Black Association, carbon black's use in tires, rubber and plastic products, printing inks and coatings is related to such properties as specific surface area, particle size and structure, conductivity and color. Approximately 90% of carbon black (CB) is used in rubber applications, 9% as a pigment, and the remaining 1% as an essential ingredient in hundreds of diverse applications.

Ide et al (2003) investigated carbon-phenolic molded compounds. A carbon-phenolic resin molding compound was obtained by reacting phenol with an aldehyde in the presence of a catalyst (tertiary amines, carbonates, hydroxides and oxides of alkali metals), while mixing them with a carbon powder (contains 90 wt % or more of fixed carbon) such that a content of the carbon powder in the molding compound was 75 wt % or more. The thermal conductivity and the electrical conductivity of the molded articles can be remarkably improved without deterioration in the mechanical properties

Martin and Shahbazi (1986) developed a resistor coating compound through post-blending of phenolic resins (no water in resin) and carbon (85:15 to 50:50 wt ratio), in which the phenolic resin system was comprised of a low liquid short chain phenolic resin having a number average molecular weight of from about 300 to about 400 and a solid long chain phenolic resin having a number average molecular weight from about 400 to about 500. The carbon component was a mixture of carbon black having a surface area of 500 m²/g-1500 m²/g and graphite particles.

Mitake et al (1983) developed a bead filler rubber composition comprising rubber, carbon black and Novolak-type phenolic resin, and this composition was adapted to be used as a bead rubber of a tire.

Matsumora (2002) developed a conductive resin composition comprising: a binder resin consisting essentially of a phenolic resin and a conductive filler containing carbon beads and carbon black, wherein the conductive filler content was in the range of 45% to 51% by weight. The purpose of this invention was to provide a conductive resin composition which has excellent wear resistance and conductivity.

Bryner (1963, 1967, 1968) developed phenolic resin glue mix for plywood. He used phenol-formaldehyde resin in combination with extenders consisting of partial carbonized cellulosic materials, organic extender and others to make glue mix, or PF resin in combination with extenders including carbon black and other carbons, and basic metal catalyst. The improved glue mix formulation was obtained by post-blending fine carbon particles with PF resin.

Nishimiya et al (2003) and Kaneiwa (2003) developed heat-emitting plywood. They used carbon black and graphite as electricity conductors in the glue mix (5-40 parts of carbon black, 5-40 parts of graphite and 100 parts of adhesive resin). After curing, the glue layer would generate heat when connected to the electricity.

Matuana (2002, 2003) developed glue mix formulations, in which the weight of filler was about 5% of the resin weight. The filler was synthetic graphite or other carbon. He used a commercial PF resin for his investigation, and the average value of shear strength of plywood bonded with the glue mix containing the PF resin and synthetic graphite was not significantly different from that of the PF glue mix without synthetic graphite (95% confidence). Other fillers included natural graphite, metal, carbon, silicon carbide, etc.

Several attempts have been made to incorporate carbon black into phenolic resins, specifically to act as a matrix. However, when carbon black is incorporated into the phenolic resin matrix, several problems and/or issues have arisen: 1) commercial phenolic resins can be in the form of powder or liquid instead of aqueous solution; 2) when incorporating carbon black into a phenolic resin, the organic solvent used would have to mix the CB/PF together well before being removed, and the resulting mixture would need to be further mixed by kneading at an elevated temperature or by dry-blending the carbon black with phenolic resin and further mixing by kneading at an elevated temperature, and 3) the resulting carbon black/phenolic resin mixtures are in most cases, suitable as structural composites or as a reinforcement agent to improve certain properties, but are rarely used for wood adhesives.

Described herein is a method that applies carbon black and the like to enhance the bonding strength of a phenol-formaldehyde or lignin-phenol-formaldehyde resin as a wood adhesive.

### SUMMARY

Disclosed herein are adhesive compositions and methods for making adhesive compositions, and methods for making ligno-cellulosic composites with such adhesive compositions.

In accordance with one aspect of the present invention, there is provided a method of producing a phenol-formaldehyde adhesive polymer, the method comprising the steps of: providing at least one phenolic compound, at least one formaldehyde compound, an alkali metal hydroxide, water and at least one carbon black; mixing the at least one phenolic compound, the at least one formaldehyde compound, the alkali metal hydroxide, the water and the carbon black to produce a methylolation medium at a pH of about 10 or less: maintaining the medium at a methylolation temperature to produce a methylolated medium reacting with the water predominantly; and increasing the temperature of the methylolated medium to produce the phenol-formaldehyde polymer via a condensation reaction.

In accordance with an aspect of the method described herein, the weight % of carbon black is less than 3 weight % of the adhesive polymer starting materials.

In accordance with another aspect of the method described herein, the weight % of the carbon black is less than 1 weight % of the adhesive polymer starting materials.

In accordance with yet another aspect of the method described herein, further comprising adding more of the formaldehyde compound to the methylolation medium.

In accordance with still another aspect of the method of described herein, further comprising adding more of the alkali metal hydroxide to the methylolated medium.

In accordance with yet still another aspect of the method described herein, the at least one carbon black is added to the phenol-formaldehyde after condensation.

In accordance with still another aspect of the present invention, there is provided a phenol-formaldehyde adhesive polymer comprising: a phenolic compound selected from the group consisting of phenol, a lignin or combinations thereof; a formaldehyde compound selected from the group consisting of formaldehyde, paraformaldehyde and combinations thereof; water; an alkali metal hydroxide: and a carbon black, wherein the weight percentage of the carbon black is less than 3 weight % of the adhesive polymer starting materials (weight %).

In accordance with a further aspect of the polymer described herein, the weight percentage of carbon black is less than 1% w/w of the starting materials.

In accordance with a further aspect of the present invention, there is provided a plywood comprising a phenolic compound selected from the group consisting of phenol, a lignin or combinations thereof; a formaldehyde compound selected from the group consisting of formaldehyde, paraformaldehyde and combinations thereof; water; an alkali metal hydroxide; and a carbon black, wherein the weight percentage of the carbon black is less than 3 weight % of the compound starting materials (weight %), between wooden layers of the plywood.

In accordance with yet a further aspect of the plywood described herein, the weight percentage of carbon black is less than 1% w/w of the starting materials.

In accordance with one aspect of the present invention there is provided a method of producing a phenol-formaldehyde polymer comprising carbon black, the method comprising: providing the carbon black, a phenol, formaldehyde or a formaldehyde substitute, a base to produce a polymerization medium, and raising the temperature of the medium above the phenol-formaldehyde polymerization temperature.

In accordance with another aspect of the present invention, there is provided a lignin-phenol-formaldehyde polymer composition comprising: a phenol compound, formaldehyde or a formaldehyde equivalent, a hydroxide, carbon black and lignin.

### BRIEF DESCRIPTION OF THE DRAWINGS

Certain embodiments will be described in more detail with reference to the following drawings:

FIG. 1 is a bar graph illustrating the wet shear strength of 3-ply yellow birch plywood after 48 hour soaking treatment according to embodiments of the present invention compared with commercial PF and a PF polymer made without CB.

FIG. 2 is a bar graph illustrating the relationship between bonding strength (with thin Aspen veneers) and carbon black loading level according to embodiments of the present invention compared with kraft lignin PF (KLPF).

FIG. 3 is a bar graph illustrating the wet shear strength of 2-ply yellow birch plywood after 48-hour soaking treatment according to embodiments of the present invention compared with kraft lignin PF (KLPF).

### DESCRIPTION OF INVENTION

Those skilled in the art will recognize that the basic principles to be described here are applicable to any lignocellulosic composites that consist of a natural fiber and an adhesive system (usually applied at a charge of less than 10% based on oven-dry cellulosic material weight). The adhesive system is usually of the thermoset type of resins which are available in various forms such as aqueous solution/dispersion or in a powder form. Using such an adhesive, composites materials are formed at elevated temperatures and pressures.

The following terms will be used herein to illustrate the main aspects and claims of this invention:

“Lignin” generally refers to a group of phenolic polymers that in their native form give strength and rigidity to plant materials. Lignins are complex polymers, and tend to be referred to in generic terms. Lignins may include, any one or more of several possible industrial lignin preparations, such as kraft lignin, a by-product of the kraft pulping process, Soda lignin, a by-product of the soda pulping process, lignosulfonates, a by-product of the sulphite pulping process, and organosolv lignin, a by-product of a bio-ethanol and/or other solvent process, and analytical lignin preparations, such as dioxane acidolysis lignin, milled-wood lignin, Klason lignin, cellulolytic enzyme lignin, etc.

“Lignin component” represents any lignin-containing material. Lignin component can be derived from industrial lignin preparations or analytical lignin preparations, which originates from renewable resources, especially from lignocelluloses. The lignin component can be a material or a composition, which incorporates modified, treated or purified portions of lignin.

“Lignocellulosic materials” include all plant materials. For example, such materials include wood materials (such as wood strands, wood fibers or wood chips or wood particles), grass materials (such as hemp or flax), grain materials (such as the straw of rice, wheat, corn), etc.

“Carbon Black” [C.A.S. No. 133-86-4] is virtually pure elemental carbon in the form of colloidal particles that are produced by the incomplete combustion of gaseous or liquid hydrocarbons under controlled conditions. Two carbon black manufacturing processes (furnace black and thermal black) produce nearly all of the world's carbon blacks, with the furnace black process being the most common. The furnace black process uses heavy aromatic oils as feedstock. The thermal black process uses natural gas, consisting primarily of methane or heavy aromatic oils, as feedstock material (International Carbon Black Association). Carbon blacks (CB), derived from biomass could be obtained by pyrolysis of biomass (Abdul Khalil et al. 2010). Carbon black is chemically and physically distinct from soot and black carbon, with most types containing greater than 97% elemental carbon arranged in the aciniform (grape-like cluster) particulate form. On the contrary, typically less than 60% of the total particle mass of soot or black carbon is composed of elemental carbon, depending on the source and characteristics of the particles (shape, size, and heterogeneity) (International Carbon Black Association). Carbon black from vegetable origin is used as a food coloring, in Europe known as additive E153

Carbon black is classified according to a system implemented in 1968 by the ASTM Committee D24. The code consists of a prefix letter followed by a three-digit number. The prefix indicates the type of curing process, either “N” for normal or “S” for slow curing. Presently, almost all rubber grades carry the “N” prefix. The first of the three numeric digit code groups the mean particle diameter (in nanometers) of the grade. The division of carbon black by the typical average particle size is shown below.

TABLE 1
Carbon Black First Digit Assignment System by ASTM
in Carbon Black Nomenclature System

| First Digit | Typical Average particle size, nm |
|---|---|
| 0 | 1 to 10 |
| 1 | 11 to 19 |
| 2 | 20 to 25 |
| 3 | 26 to 30 |
| 4 | 31 to 39 |
| 5 | 40 to 48 |
| 6 | 49 to 60 |
| 7 | 61 to 100 |
| 8 | 101 to 200 |
| 9 | 201 to 500 |

The second and third digits are assigned to new products in successive order in the same first digit classes as they are developed. The grades therefore range from N110 to N990. Generally, the abrasion resistance properties and the price of manufacture of the carbon black increase with smaller particle size and smaller numbers in the first digit. A preferred carbon black is N660.

Carbon black from different feedstock, different manufacturing processes could have different properties. The important properties could include surface area, primary particle size, structure (composition), and surface chemistry etc. Primary particles is the smallest unit of a carbon black particles, which could have different dimension of size, different shape and crystallinity and different graphitic content. Even though most of primary particles have near-spherical shape, but some primary particles have aspect ratios higher than those of true sphere. The higher aspect ratio will result in higher surface area per volume and provides more wettable area which improving dispersion ability. Carbon black aggregates are complex cluster of fused primary particles, which have different size, shape, voids volume and structure. The shape and structure of aggregates impact dispersibility and the void volume impacts wettability, which could impact the performance used in a liquid medium such as a coating, paint or ink or as for our case (additive in adhesive).

A phenolic compound comprises compound of general formula ArOH, where Ar is phenyl (phenol), substituted phenyl or other aryl groups (e.g. tannins) and a lignin and combinations thereof. The phenolic compound may be selected from the group consisting of phenol, a lignin and combinations thereof.

In a preferred embodiment the phenolic compound is phenol. In another preferred embodiment the phenolic compound is a combination of phenol and a lignin. Starting materials are understood as all compounds and products added to produce the adhesive polymer disclosed herein.

A formaldehyde compound may be selected from the group consisting of formaldehyde and paraformaldehyde and combinations thereof.

The above term descriptions are provided only to aid the reader and should not in any way be construed to have a scope limiting the appended claims.

The methods described herein relate to: 1) an in-situ polymerization technique to incorporate carbon black into phenolic resins by which the resulting polymers come into intimate contact with carbon black thus improving the interaction of carbon black with polymers; 2) the preparation of a carbon black-phenolic adhesive in an aqueous solution; and 3) the preparation of wood composites with the resulting phenolic adhesives reinforced with carbon black.

One potential source for the biopolymer derived matrix is lignin, wood's natural adhesive. Lignin is produced in large quantities by the pulp and paper industry and, in particular, kraft pulp mills where it is primarily used as a fuel in the pulping process. However, with increasing pulp production at such mills, the recovery boiler becomes, at some point, the production bottleneck. A convenient and cost-effective way to offload the recovery boiler with respect to calorific load is to remove some of the lignin from the black liquor to be fired into the recovery boiler and direct it to other uses. Due to its high phenolic content, lignin has been seen as a good candidate to partially replace the petroleum-based adhesives used in commercial lignocellulosic composites. Due to the inherently poorer mechanical performance to date of bio-derived matrices, the need exists for additives to be used to enhance their performance in commercial lignocellulosic composites.

The present invention demonstrates that a small amount of carbon black incorporated into phenolic resins (e.g. phenol-formaldehyde resins) under appropriate processing conditions produces wood composites that are superior in performance compared to the same wood product made without incorporation of carbon black. It also demonstrates that incorporation of carbon black into biopolymer-derived resin polymers (e.g. lignin-phenol-formaldehyde resins) can produce under appropriate processing conditions wood composites that are superior in performance compared to the same wood products made without carbon black.

Disclosed herein are: preparations of carbon black-phenol-formaldehyde resin/adhesive formulations and carbon black-phenol-formaldehyde-lignin resin/adhesive formulations, adhesives compositions and methods for making adhesive compositions, and methods for making ligno-cellulosic composites with such phenolic adhesive resins.

A first variant of this invention is an aqueous liquid form adhesive composition described herein, which includes at least one carbon black component, at least a phenolic component, and at least an aldehyde component. A second variant of this invention is an aqueous liquid adhesive composition described herein, which includes at least one carbon black component, at least one lignin component, at least one phenolic component, and at least one aldehyde component. A third variant of this invention is the flexibility of introducing carbon black or the like into the adhesive resin system, which can be done at the beginning, or during, or after the resin synthesis.

Also disclosed herein are lignocellulosic composites that comprise the lignocellulosic materials and adhesive compositions, the methods for making adhesives, and the methods for making the composites.

Preparation of the carbon black-phenol-formaldehyde and carbon black-lignin-phenol-formaldehyde resin/adhesive formulations.

Phenol-formaldehyde (PF) resins are known to be prepared from two main chemicals (phenol and formaldehyde) that are reacted at elevated temperatures through methylolation and condensation to form a phenolic polymer. Polymer formation is strongly related to the molar ratio of phenol to formaldehyde, and the pH at which the reaction is carried out. A phenolic resin is called a Novolac resin when the molar ratio of formaldehyde to phenol was less than 1 and the pH at which it was made was low. The phenolic resin is of the Resol type when the molar ratio of formaldehyde to phenol used was higher than 1, and the pH at which it was made was higher than 7. Resol-type phenolic resins will crosslink, usually at elevated temperatures.

The method described herein, is meant to incorporate carbon black in phenol-formaldehyde adhesives or lignin-phenol-formaldehyde adhesives and thus improve the bonding properties of wood composites and mechanical properties of wood composites.

More specifically, the method described herein: 1) incorporates carbon, preferably carbon black, into phenol-formaldehyde resins or lignin-phenol-formaldehyde resins through in-situ polymerization, and 2) incorporates carbon black into lignin-phenol-formaldehyde resins through post-blending.

Below is described the general chemistry associated with forming the final adhesive mixtures.

The first step of the method described herein is the mixing of lignin (if applicable), phenol, formaldehyde, a hydroxide and the carbon black (i.e. see EXAMPLES 1, and 2) and allowing the mixture to react at elevated temperatures. The order of addition of the above starting compounds may vary. In a preferred embodiment, phenol is added with water first. Then caustic (the hydroxide, in a preferred embodiment is sodium and/or potassium hydroxide) is loaded to adjust the pH in the range of 7 to 11, preferably less than 10. The form of the hydroxide solution is usually 50% by weight. Subsequently, carbon black is added followed by formaldehyde which is added slowly over a period of 30 min. This prepared medium methylolation is, subsequently, heated to methylolation temperatures ranging between 60-75° C., preferably 70° C., for a period of 1 to 2 hours. At this time, the methylolation reaction takes place, with formaldehyde typically reacting at the ortho- (and para) position of the phenol and/or with available reaction sites on the lignin, to produce a methylolated medium comprising methylolated phenols.

The second step of the method described herein is the raising of the temperature to 75-95° C. to promote a condensation reaction(s) of the methylolated phenols, and preferably 80-85° C. for a certain period of time. At this stage, temperature control is important to obtain a proper viscosity range.

The method further includes a third step, where the temperature is reduced to temperatures ranging between 60-75° C., preferably 70° C. During this step, a second portion of formaldehyde is slowly added over 30 min and the temperature is kept at 70° C. for another 30-60 min.

It should be noted here that it is possible to combine the first and third steps into a single step to produce a similar phenolic resin. The phenolic resins obtained in a single step process may have different properties compared to the phenolic resins produced in two steps.

The fourth step is loading a second portion of sodium hydroxide over 10 min and raising the temperature to 80-85° C., while closely monitoring the viscosity. The viscosity is typically varied for different applications and is in the range of approximately 100-200 cps for OSB with a solids content around 45-60%, approximately 250-3000 cps or higher for plywood applications, and approximately 60-200 cps for spray-drying conversion to a powder resin used in OSB manufacturing. At this stage, temperature control is important to obtain the proper viscosity range.

Once the first and third steps are combined into one step, the second and fourth steps can also be combined into one step in which polymer condensation takes place until the required viscosity is reached at a certain pH.

The quantities of raw materials added at each step, the temperature at which the reactions occur and/or the molar ratios of formaldehyde to phenol, may all vary depending on the final phenolic resin/adhesive requirements. In practice, the molar ratio of formaldehyde to phenol is preferably from 1.5:1 to 3.0:1. More preferably, the molar ratio varies from 1.8:1 to 2.8:1; the weight ratio of base (sodium hydroxide and/or potassium hydroxide) to phenol and (lignin if applicable) varies from 0.03:1.00 to 0.30:1.00. More preferably, the weight ratio varies from 0.10:1.00 to 0.20:1.00.

The following examples describe the general chemistry of several preferred embodiments.

### Example 1

### Preparation of Carbon Black-Phenol-Formaldehyde Adhesive

Carbon black was formulated with phenol (99 wt %) 150 parts by weight; formaldehyde (40% wt %) 240 parts by weight; sodium hydroxide (50 wt %) 55 parts, carbon black (N660, powder) 4.05 parts, and water 100 parts.

In a 1-liter reactor vessel, phenol, one third of the caustic, two thirds of the water, and carbon black were added and the system was heated to around 60° C. Subsequently, one half of the formaldehyde solution was added over 30 minutes and another one fourth of water was added. At this point, the system temperature was raised to 65-70° C. and kept constant for 30 minutes. The temperature was then raised to 80-85° C., kept at this level for one hour, and then reduced to 65-70° C. At this point, the remaining formaldehyde was added over 30 minutes as well as the remaining water. The system was kept at 65-70° C. for another 30 minutes. Subsequently, the remaining sodium hydroxide was added and the temperature was kept at 80-85° C. until the required viscosity (350 cps) was reached.

The reaction was terminated by cooling the system with cooling water to around 30° C. The resulting products were transferred to a container and stored in a cold room (4° C.) before use. The adhesive was coded as PF-CB. The CB content was 1.5 wt % based on the solids content of the polymer adhesive.

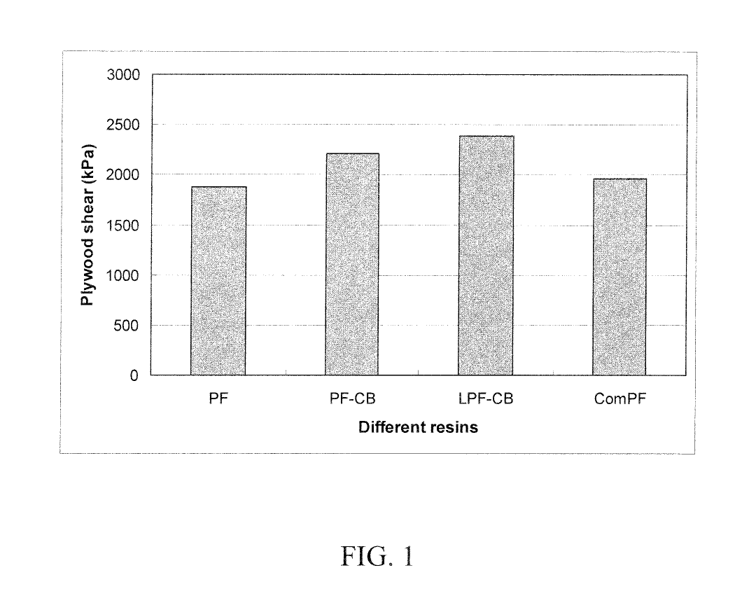

Yellow birch veneer strips (1.5 mm thick×120 mm wide×240 mm long) were selected and cut from sliced veneer supplied by local supplier, which were cut from fresh yellow birch logs with the long direction being parallel to the wood grains, and then conditioned at 20° C. and 20% relative humidity (RH) for two weeks. The adhesive polymer formulations prepared above were applied to one side of each face layer (the manufacturing condition for 3-ply plywood making is given in Table 2). After manufacturing, the panels were conditioned at 21° C. and 20% RH until consistent moisture content was reached. These three-ply plywood samples were then cut into testing specimen sizes (25 mm wide×80 mm long) for a plywood shear test. At least thirty specimens were cut from each plywood panel of which half of the specimens were in the pulled open mode while the other half of the specimens were in the pulled closed mode. The cross-section of the test samples was 25 mm by 25 mm. Specimens were tested wet after 48 hours of soaking in 20° C. running water. The results are shown in FIG. 1. The shear strength of plywood, made with PF-CB, increased by 12.7% compared with one commercial phenolic resin, and by 17.7% compared with a lab synthesized phenolic resin (PF).

TABLE 2
the 3-ply plywood composites manufacturing conditions

| | |
|---|---|
| Wood species | Yellow birch |
| Thickness of veneer | 1.5 mm |
| Plywood | 3-ply plywood |
| Resin spread rate on face ply | 200-220 g/m² |
| Open assembly time | 2-20 minutes |
| Close assembly time | 2-10 minutes |
| Temperature | 150° C. |
| Pressure | 1500 kPa |
| Pressing time | 7 min |
| Pressure release time | 30 sec. |

### Example 2

### Preparation of Carbon Black Lignin-Phenol-Formaldehyde Adhesive

Carbon black was formulated with phenol (99 wt %): 150 parts by weight; formaldehyde (40% wt %): 210 parts by weight; sodium hydroxide (50 wt %): 70 parts by weight, carbon black (N660, powder): 5.25 parts by weight, lignin (92%): 43.4 parts by weight and water 130 parts by weight.

In a 1-L reactor vessel, phenol, two fifths of the caustic, two thirds of the water, and all of the carbon black were added and the system was heated to around 60° C. Subsequently, one half of the formaldehyde solution was added over 30 minutes and another one fourth of the water was added. The system temperature was raised to 65-70° C. and kept at this level for 30 minutes. The temperature was then raised to 80-85° C. and kept at this level for one hour. At this point, the temperature was reduced to 65-70° C., and the remaining formaldehyde was added over 30 minutes along with the remaining water. The system temperature was kept at 65-70° C. for another 30 minutes. The remaining sodium hydroxide was then added and the temperature was kept at 80-85° C. until the required viscosity was reached (350 cps).

The reaction was terminated by cooling the system with cooling water to around 30° C. The resulting products were transferred to a container and stored in a cold room (4° C.) before use. The adhesive was coded as LPF-CB. The CB content was 1.5 wt % based on the solids content of the polymer adhesive.

Three-ply plywood composites were made with this resin under the processing conditions as shown in Table 2 of EXAMPLE 1. Subsequently, the sample specimens were cut and tested under the same conditions as those used for the wood composite samples made with the resin of EXAMPLE 1.

### Example 3

### Preparation of Phenol-Formaldehyde Adhesive as a Control

In this example, all materials are counted by weight parts, in which phenol (99 wt %) is 150 parts by weight; formaldehyde (40% wt %) is 240 parts by weight: sodium hydroxide (50 wt %) is 55 parts, and water is 100 parts.

In a 1-L reactor, phenol, one third of the caustic and two thirds of the water were added and the system was heated to around 60° C. Subsequently, one half of the formaldehyde solution was added in over 30 minutes and another one fourth of the water was added. At this point, the system temperature was raised to 65-70° C. and kept at this level for 30 minutes. Subsequently, the temperature was raised to 80-85° C., kept at this level for one hour, and then reduced to 65-70° C. The remaining formaldehyde was then added over 30 minutes along with the remaining water, and the system was kept at 65-70° C. for another 30 minutes. Finally, the remaining sodium hydroxide was added and the temperature kept at 80-85° C. until the required viscosity was reached (350 cps).

The reaction was terminated by cooling the system with cooling water to around 30° C. The resulting products were transferred to a container and stored in a cold room (4° C.) before use. The adhesive was coded as PF.

Three-ply plywood composite samples were made with this resin under the processing conditions shown in Table 2 of EXAMPLE 1. Subsequently, the specimens were cut and tested at the same conditions as those used for the wood composites made with the resin of EXAMPLE 1.

Three-ply plywood composites were also made with one commercial phenolic resin under the same processing conditions as outlined above and this resin was coded as ComPF. The specimens made were cut and tested under the same conditions as those used for the wood composites made with the resin of EXAMPLE 1.

The plywood test sample results are listed in the following table:

TABLE 3
Bonding properties of 3-ply plywood made with phenolic resins
with or without CB

| | | Shear | Improvement | improvement |
|---|---|---|---|---|
| Example | | Strength* | Based on Lab | Based on |
| No | Code | (kPa) | PF (Ex. 3) (%) | ComPF (%) |
| 1 | PF-CB | 2216 | 17.7 | 12.66 |
| 2 | LPF-CB | 2386 | 26.8 | 21.3 |
| 3 | PF | 1883 | 0 | −4.3 |
| | ComPF | 1967 | 4.4 | 0 |

*The specimens were soaked in water for 48 hours and tested in wet

From Table 3, we can see that the 3-ply plywood composites made with both PF-CB and LPF-CB demonstrate shear strengths that are higher than the corresponding controls by 12.66% and 21.3%, respectively.

Each shear strength result was obtained from an average of 30 specimens, half of which were pull-open and the other half were pull-close for the plywood-shear tests). FIG. 1 illustrates the results of the tests; where PF-CB is from EXAMPLE 1, LPF-CB is from EXAMPLE 2, PF is from EXAMPLE 3, ComPF is a commercial PF resin.

### Example 4

### Preparation of Lignin-Phenol-Formaldehyde Adhesive as Basis Material & a Control

In this example, all materials are counted by weight parts to prepare a formulation of phenol (98%): 500 parts by weight, kraft softwood lignin from black liquor (90%): 272 parts by weight, paraformaldehyde (91%): 430 parts by weight, sodium hydroxide (50 wt %): 140 parts by weight, and water: 1310 parts by weight

In a 4-L reaction vessel, phenol, kraft softwood lignin, paraformaldehyde, some of the sodium hydroxide (70 parts), and some of the water (800 parts) were added to make a medium having a solids content around 50 wt %. The system was heated to approximately 70° C. and was kept at this temperature for one and a half hours. Subsequently, the remaining sodium hydroxide and water were added, with the temperature maintained at approximately 70° C. for another half an hour. Afterward, the temperature was increased to 80-90° C., and the viscosity was monitored. When the viscosity of the resin system reached to 150-200 cps, the reaction was stopped by cooling the reactor to approximately 30° C. The contents were transferred to a container and stored in a cold room for later use. The adhesive was coded as KLPF. The viscosity of KLPF was 150 cps and the pH of the KLPF was 10.2.

### Examples 5-9

### Preparation of Carbon-Black Lignin-Phenol-Formaldehyde Adhesive Through Post-Blending

The KLPF made in Example 3 was used to prepare carbon-black lignin-phenol-formaldehyde adhesives through post-blending with carbon black. The KLPF was divided into 6 portions, in which one was used as a control, and the other portions were firstly mixed in a 500-mL mortar with pestle with the required amount of carbon black (please see Table 4) to make sure the carbon black was well dispersed in the KLPF. The carbon black used was N660 which is mainly used for tire applications. Subsequently, the mixture was transferred to a mixer in which it was mixed at a speed of 2000 RPM for 15 minutes with High Speed Dispenser (Ragogna Machinery Ltd). Finally, the mixture was transferred to a container and stored at 4° C.

TABLE 4
Carbon black content and parameters for 2-ply plywood making

| | | | | Open | Close |
|---|---|---|---|---|---|
| | | | | Assembly | Assembly |
| | | Carbon Black | Spread Rate | Time | Time |
| Example | Code | (% wt*) | (g/m²)** | (minute) | (minute) |
| 4 | KLPF | 0.000% | 80 | 10 | 15 |
| 5 | CB01 | 0.025% | 80 | 10 | 11 |
| 6 | CB02 | 0.050% | 80 | 10 | 8 |
| 7 | CB03 | 0.100% | 80 | 10 | 5 |
| 8 | CB04 | 0.200% | 80 | 10 | 13 |
| 9 | CB05 | 0.300% | 80 | 10 | 10.5 |

*Based on resin solids; **spread rate was based on resin solid weight

Two methods were adopted to evaluate the performance of lignin based phenolic resins (KLPF) with or without carbon black: 1) by making use of the Automated Bond Evaluation System (ABES) and 2) by testing the wet shear strength performance of 2-ply plywood.

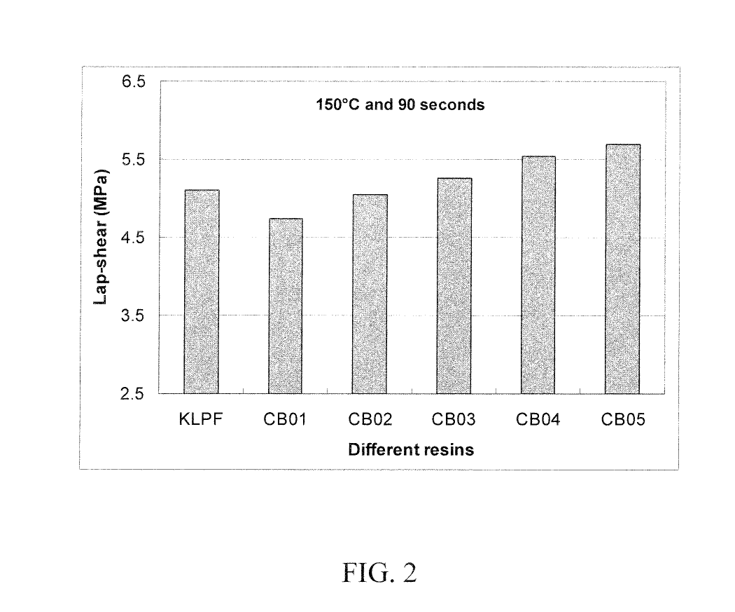

For the ABES bonding tests, specimens were prepared with Aspen strands of 0.8 mm thick, 20 mm long and 117 mm wide using a die cutter supplied by Adhesive Evaluation Systems (Corvallis, Oreg.)—the cross sectional area was 5×20 mm. The resin loading was 1.45 mg/cm² (based on resin solids weight). The press temperature was 150° C. The press time was 90 seconds. Five replicates were tested for each type of resin. The average numerical values of Lap-sheer tests of FIG. 2 (MPa) are for KLPF=5.10; CB01=4.74: CB02=5.05: CB03=5.26; CB04=5.54 and CB05=5.69. The test results are illustrated in FIG. 2, clearly illustrates that the dry bonding strength increased with increasing carbon black loading. The resins were tested by the Automatic Bond Evaluation System (ABES) at 150° C. press temperature and 90 seconds press time. Each bonding strength data was from an average of 5 specimens.

For 2-ply plywood making, 2-ply plywood processing conditions are shown in Table 5. The peeled yellow birch veneers 120 mm×200 mm×1.5 mm were used. Before making panels, the veneers were conditioned at 20% relative humidity (RH) and 20° C. for 2 weeks. Subsequently, KLPF resin was applied on the tight side of the veneers. The tight sides were placed on the inside for 2-ply test plywood. Actual open assembly time and close assembly time are listed in Table 4

TABLE 5
Processing coditions for the preparation of 2-ply plywood composites

| | |
|---|---|
| Wood species | Yellow birch |
| Thickness of veneer | 1.5 mm |
| Plywood | 2-ply plywood |
| Resin spread rate | 80 g/m² (based on resin solid) |
| Open assembly time | 2-20 minutes |
| Close assembly time | 2-10 minutes |
| Temperature | 150° C. |
| Pressure | 1500 kPa |
| Pressing time | 3 min |
| Pressure release time | 30 sec. |

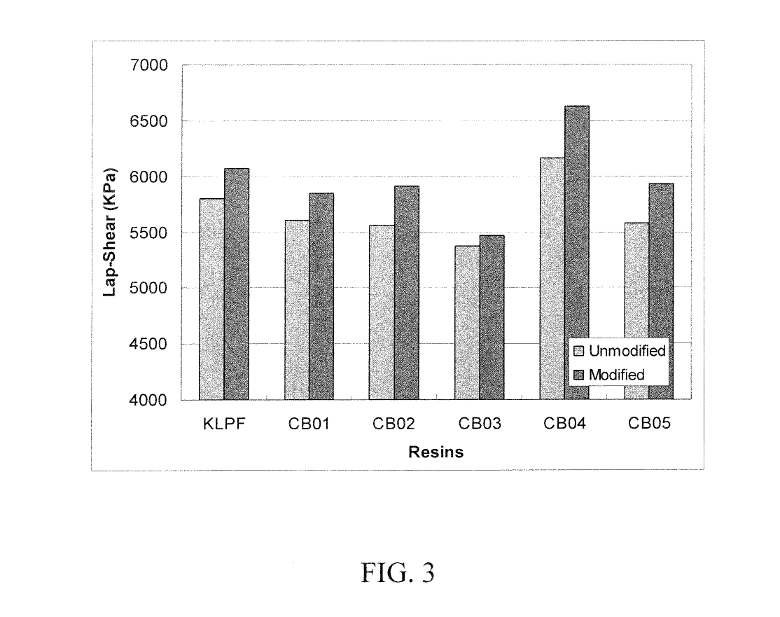

FIG. 3 illustrates the result of the modified and unmodified plywood panels made using KLPF adhesives with and without carbon black. Each shear strength data was from an average of 16 specimens. The average numerical values of Lap-sheer (in kPa for the six panels illustrated in FIG. 3 (unmodified/modified respectively) are: KLPF=5804/6076; CB01=5603/5851: CB02=5560/5909; CB03=5375/5466; CB04=6165/6630; and CB05=5583/5930.

The 2-ply plywood panels were placed in a conditioning chamber at 20% RH and 20° C. for one week. Over 16 specimens were cut from each panel with dimensions of 25 mm by 75 mm. The cross-sectional area was 25 mm by 12.5 mm. The specimens were soaked for 48 hours in running water at 20° C., taken out and put in a plastic bag to keep them wet and, subsequently, tested within one hour at a loading speed of 3000 N/min. Plywood strength and wood failure were evaluated using the average of all data (coded unmodified). If the wood failure was higher than 80% at the cross-section, up to 25% of the lower strength values were removed (coded modified).

The 2-ply plywood panels bonded with KLPF resin containing 0.2 wt % CB (CB04) gave the highest average wet shear strength among all the carbon black-containing KLPF resins.

### Examples 10-15

### Preparation of Commercial PF Resin Reinforced with Carbon Black Through Post-Blending

Another commercial PF resin (coded as ComPF02) was used to prepare carbon-black PF adhesives through post-blending with carbon black. The commercial PF was divided into several portions, in which one was used as a control, and the others were firstly mixed in a 500-mL stainless steel container with glass rod with the required amount of carbon black, which is Monarch 120 from Columbia Carbon Co. Ltd (please see Table 6). The mixture was mixed at a speed of 2000 RMP for 15 minutes with High Speed Dispenser (Ragogna Machinery Ltd), and then the mixture was transferred to a container and stored at 4° C.

TABLE 6
Carbon black content and parameters for 3-ply plywood making

| | | | | Open | Close | |
|---|---|---|---|---|---|---|
| | | Carbon | Spread Rate | Assembly | Assembly | |
| | | Black | per glue line | Time | Time | Temp |
| Example | Code | (% wt*) | (g/m²)** | (minute) | (minute) | (° C.) |
| 10 | ComPF02 | 0.00% | 177-184 | 4.5-7.0 | 2.0-4.0 | 152-158 |
| 11 | PF-CB01 | 0.05% | 179-184 | 3.5-7.5 | 2.0-4.0 | 152-160 |
| 12 | PF-CB02 | 0.12% | 178-187 | 4.5-7.0 | 2.0-4.0 | 152-160 |
| 13 | PF-CB03 | 0.23% | 178-182 | 4.5-7.5 | 2.0-5.0 | 153-160 |
| 14 | PF-CB04 | 0.46% | 177-182 | 4.0-7.0 | 2.0-4.0 | 152-160 |
| 15 | PF-CB05 | 0.99% | 178-184 | 4.0-6.5 | 2.0-4.0 | 152-160 |

*Based on resin solids;
**spread rate was based on liquid resin weight

Three-ply plywood composite samples were made with these resins under the processing conditions in Table 6, and other conditions were the same as shown in Table 2 of EXAMPLE 1, such as pressure, pressing time, pressure release time etc.

After manufacturing, the panels were conditioned at 21° C. and 20% RH until consistent moisture content was reached. These three-ply plywood samples were then cut into testing specimen sizes (25 mm wide×80 mm long) for a plywood shear test. For all panels, two specimens were pre-cut and tested after 48 hour soaking and pulled closed mode were determined. After that, all specimens were cut from remain panels in the pulled closed mode. 50% of the specimens were subjected to the 48 h soaking test in which they were soaked in running water at 20° C. for 48 hours and tested in wet. The other 50% were subjected to the boil-dry-boil test in which they were submerged in boiling water for 4 h, dried in the oven at 60° C. for 20 h, submerged again in boiling water for another 4 h, and tested in wet.

The plywood test sample results are listed in the following table

TABLE 7
Bonding properties of 3-ply plywood made with another commercial
phenolic resins with or without CB

| | | 48h-Soaking test | | | |
|---|---|---|---|---|---|
| | Dosage | Shear | | Boil-dry-boil (BDB) test | |
| | (% of | strength | Improvement | Shear strength | Improvement |
| Example | solids) | (KPa) | (%) | (KPa) | (%) |
| 10 | 0 | 2732 | 0 | 2385 | 0 |
| 11 | 0.05 | 3023 | 9.6 | 2582 | 7.6 |
| 12 | 0.12 | 2946 | 7.3 | 2444 | 2.4 |
| 13 | 0.23 | 2809 | 2.7 | 2376 | −0.4 |
| 14 | 0.46 | 2774 | 1.5 | 2416 | 1.3 |
| 15 | 0.99 | 2922 | 6.5 | 2507 | 4.9 |

The results showed that the addition of carbon black to the commercial PF resin can improve the plywood shear strength by 8-10% after BDB and 48 h soaking tests. At low carbon black dosage (0.05%), the plywood shear strength was higher than the one obtained by the addition of higher amounts of carbon black. This could be due to the dispersion of the carbon black particles within the solution of PF resin. When high amount of CB is used, only a small part of it is well dispersed in the resin. The other part remains aggregated. A good dispersion of the carbon black particles could be obtained either mechanically by using for example a high shear mixer or chemically by compatibilization of the carbon black before its addition to the resin formulation.

In summary, the present invention describes a carbon additive that is compatible with the phenolic adhesive resin chemistry and capable of enhancing the bonding performance of either PF or KLPF resins as wood adhesives under both dry and wet conditions. This carbon additive can be carbon black, or activated carbon, or carbon char from the pyrolysis of plants, etc. This additive is safe, economical, stable and environmentally friendly. This invention creates new opportunities for improving adhesive performance in wood composite products manufacturing and reducing adhesive resin consumption.

### REFERENCES

Abdul Khalil H. P. S., Firoozian P., Bakare I. O. Md. Akil H., A. Md. Noor, Exploring biomass based carbon black as filler in epoxy composites: Flexural and thermal properties, Materials & Design, Volume 31. Issue 7, August 2010, Pages 3419-3425
Bryner F., Phenolic resin adhesive extended with carbon and causticized amylaceous materials. U.S. Pat. No. 3,329,632, 1967
Bryner F., Phenolic resin adhesive extended with partially carbonized cellelosic materials, U.S. Pat. No. 3,337,124, 1968
Bryner F., Résines phénoliques expansés servant d'adhésifs, FR 1419576, 1963
Ide I, Nishikawa M., Higuchi H., Yoshida T., Sugita K., Carbon-phenol resin molding compound, United States Patent Application 20030036597, 2003
International Carbon Black Association, http://www.carbon-black.org/index.html
Koei N., Tsuneyoshi T., Hiroshi A., Hidetsugu E., Plywood and composite panels showing electric heat generation, JP 2003239519, 2003
Martin F. W., Shahbazi S., Low resistance resistor compositions, U.S. Pat. No. 4,600,602, 1986
Matsumora S., Conductive resin composition and encoder switch using the same, U.S. Pat. No. 6,500,361, 2002
Matuana, L. M., King J. A., Veneer-based products and method for manufacture, U.S. Pat. No. 6,589,655 B2, 2002
Matuana. L. M., King J. A., Wood-based composite board and method of manufacture, WO 2002006046, 2002
Miyake I., Okamoto K., Bundo M., Noda A., Bead filler rubber composition, U.S. Pat. No. 4,421,891, 1983
Sellers T. Jr., Wood adhesive Innovations and applications in North America, Forest product Journal, Vol. 51. No. 6, 2001
Toshihiko K., Antistatic wood-resin composite materials, their cured boards, their laminates for electric amusement machines, and their manufacture, JP 2003080510, 2003

1. A method of producing a phenol-formaldehyde adhesive polymer, the method comprising the steps of:
providing at least one phenolic compound, at least one formaldehyde compound, an alkali metal hydroxide, water and at least one carbon black;
mixing the at least one phenolic compound, the at least one formaldehyde compound, the alkali metal hydroxide, the water and the carbon black to produce a methylolation medium at a pH of about 10 or less;
maintaining the medium at a methylolation temperature to produce a methylolated medium reacting with the water predominantly; and
increasing the temperature of the methylolated medium to produce the phenol-formaldehyde polymer via a condensation reaction.

2. The method of claim 1, wherein the weight % of carbon black is less than 3 weight % of the adhesive polymer starting materials.

3. The method of claim 1, wherein the weight % of the carbon black is less than 1 weight % of the adhesive polymer starting materials.

4. The method of claim 1, further comprising adding more of the formaldehyde compound to the methylolation medium.

5. The method of claim 4, further comprising adding more of the alkali metal hydroxide to the methylolated medium.

6. The method of claim 1, wherein the at least one carbon black is added to the phenol-formaldehyde after condensation.

7. A phenol-formaldehyde adhesive polymer composition comprising:
a phenolic compound selected from the group consisting of phenol, a lignin or combinations thereof;
a formaldehyde compound selected from the group consisting of formaldehyde, paraformaldehyde and combinations thereof;
water;
an alkali metal hydroxide; and
a carbon black,
wherein the weight percentage of the carbon black is less than 3 weight % of the adhesive polymer starting materials (weight %), whereby the incorporation is through in-situ polymerization.

8. The composition of claim 7, wherein the weight percentage of carbon black is less than 1% w/w of the starting materials.

9. The composition of claim 7, comprising a molecular ratio of formaldehyde to phenol from 1.5:1 to 3.0:1.

10. The composition of claim 7, comprising a molar ratio of alkali metal hydroxide to phenol from 0.03:1.00 to 0.3:1.00.

11. The composition of claim 7, wherein the phenolic compound comprises lignin and carbon black is further incorporated by post blending.

12. A plywood or an oriented strand board comprising a phenolic compound selected from the group consisting of phenol, a lignin or combinations thereof;
a formaldehyde compound selected from the group consisting of formaldehyde, paraformaldehyde and combinations thereof;
water;
an alkali metal hydroxide; and
a carbon black,
wherein the weight percentage of the carbon black is less than 3 weight % of the compound starting materials (weight %) between wooden layers of the plywood, or the oriented strand board and the carbon black is incorporated into an intimate contact with the polymer, whereby the incorporation is through in-situ polymerization.

13. The plywood or oriented strand board of claim 12, wherein the weight percentage of carbon black is less than 1% w/w of the starting materials.

14. The plywood or oriented strand board of claim 12, wherein the phenolic compound comprises lignin and carbon black is further incorporated by post blending.
